(19) United States
(12) Patent Application Publication
(10) Pub. No.: US 2013/0298070 A1
(43) Pub. Date: Nov. 7, 2013

(54) METHOD FOR SWITCHING DISPLAY INTERFACES

(71) Applicants: Jer-Bin Lin, New Taipei City (TW); Che-Yu Lee, New Taipei City (TW); Chun-Lin Chen, Tainan City (TW)

(72) Inventors: Jer-Bin Lin, New Taipei City (TW); Che-Yu Lee, New Taipei City (TW); Chun-Lin Chen, Tainan City (TW)

(21) Appl. No.: 13/602,299

(22) Filed: Sep. 3, 2012

(30) Foreign Application Priority Data
May 3, 2012 (TW) 101115768

(51) Int. Cl. G06F 3/048

(52) U.S. Cl. 715/778

(57) ABSTRACT

A method for switching display interfaces includes a touch display device utilizing a first display interface for displaying open images of a plurality of data objects when being opened; touching a predetermined display area of the touch display device; and the touch display device switching the first display interface to a second display interface different from the first display interface for displaying the open images of the plurality of data objects when being opened.

### BACKGROUND OF THE INVENTION

1. Field of the Invention

The present invention relates to a method for switching display interfaces, and more particularly, to a method for rapidly switching different display interfaces.

2. Description of the Prior Art

As related technology keeps improving, functions of portable electronic devices are getting more powerful. Current portable electronic devices can be utilized for processing data, making a call, surfing Internet, executing application software or video games, etc. In order to make the portable electronic device easy to operate, various kinds of input devices and input methods are developed, wherein the most widely used technology at the present day is touch input technology. The touch input technology determines an inputted command of a user by sensing a track of a finger on a touch screen. Therefore, the portable electronic device needs fewer or even no physical keys for inputting.

Generally, the touch input technology requires a predetermined display interface for inputting. When the user tries to switch to a proper display interface for corresponding operation, the user needs to enter a setting page of the display interface of the portable electronic device for changing an option of the display interface. The above process is quite complicated and time consuming. Therefore, the display interfaces of the portable electronic devices of the prior art can not switch display interfaces rapidly as required by the user.

### SUMMARY OF THE INVENTION

The present invention provides a method for switching display interfaces. The method for switching display interfaces comprises a touch display device utilizing a first display interface for displaying open images of a plurality of data objects when being opened; touching a predetermined display area of the touch display device; and the touch display device switching the first display interface to a second display interface different from the first display interface for displaying the open images of the plurality of data objects when being opened.

In contrast to the prior art, the method for switching display interfaces of the present invention can predetermine preferred display interfaces, and switch display interfaces among the predetermined display interfaces by touching a predetermined display area on a touch screen. The method for switching display interfaces of the present invention can not only switch display interfaces rapidly, but also increase convenience of use.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a touch display device of the present invention.

FIG. 2 is a diagram showing the touch display device of the present invention utilizing a first display interface for displaying a plurality of data objects.

FIG. 3 is a diagram showing the touch display device of the present invention utilizing a second display interface for displaying the plurality of data objects.

FIG. 4 is a diagram showing the touch display device of the present invention utilizing a third display interface for displaying the plurality of data objects.

FIG. 5 is a diagram showing the touch display device of the present invention utilizing a fourth display interface for displaying the plurality of data objects.

FIG. 6 is a flowchart showing a method for switching display interfaces of the present invention.

FIG. 7 is a diagram showing the touch display device of the present invention utilizing a fifth display interface for displaying the plurality of data objects.

FIG. 8 is a diagram showing the touch display device of the present invention utilizing a sixth display interface for displaying the plurality of data objects.

### DETAILED DESCRIPTION

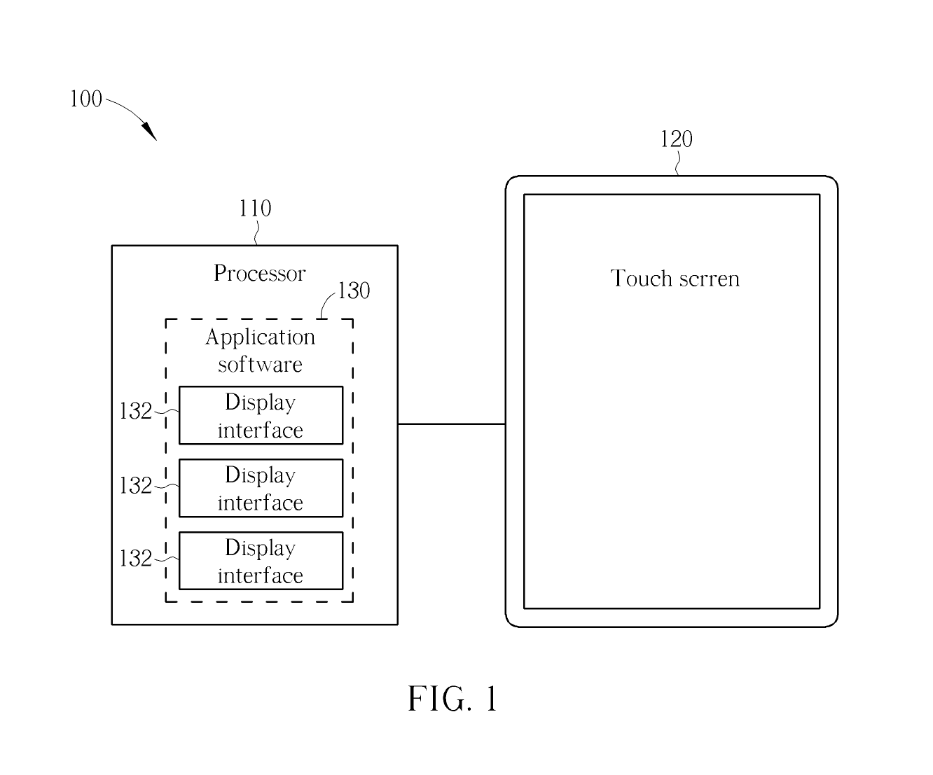

Please refer to FIG. 1. FIG. 1 is a functional block diagram of a touch display device of the present invention. As shown in FIG. 1, the touch display device 100 of the present invention comprises a processor 110 and a touch screen 120. The processor 110 is for executing application software 130. The application software 130 comprises a plurality of display interfaces 132 for allowing a user to select the required display interfaces 132. The touch screen 120 is for receiving a touch command of the user, and for displaying images. The user can predetermine the preferred display interfaces 132, such that when the processor switches the display interfaces 132 according to the touch command, the processor can switch interfaces among the predetermined display interfaces 132.

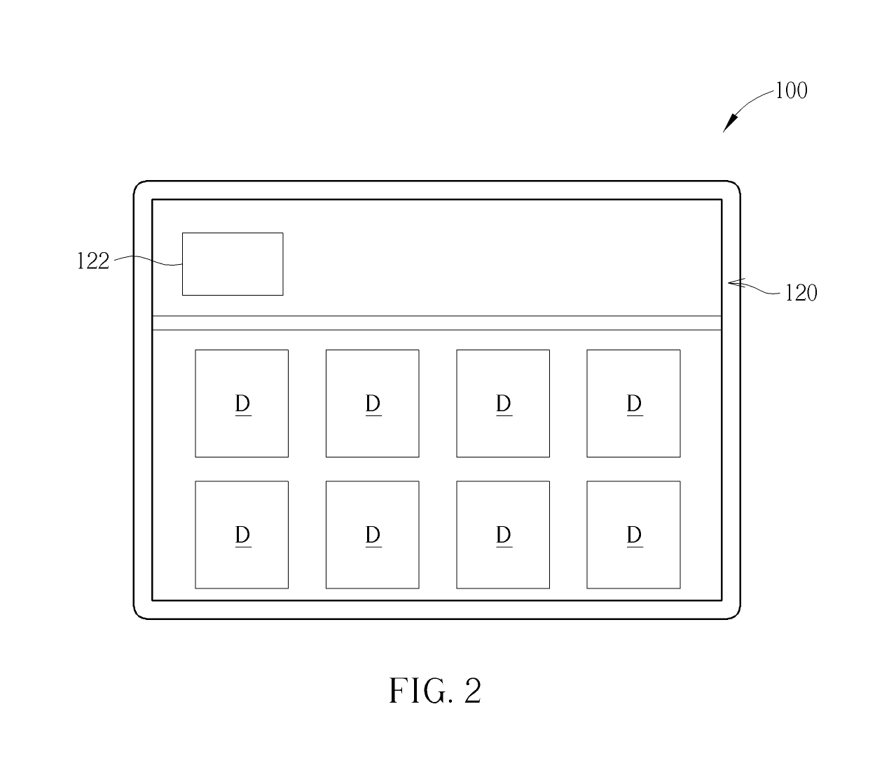

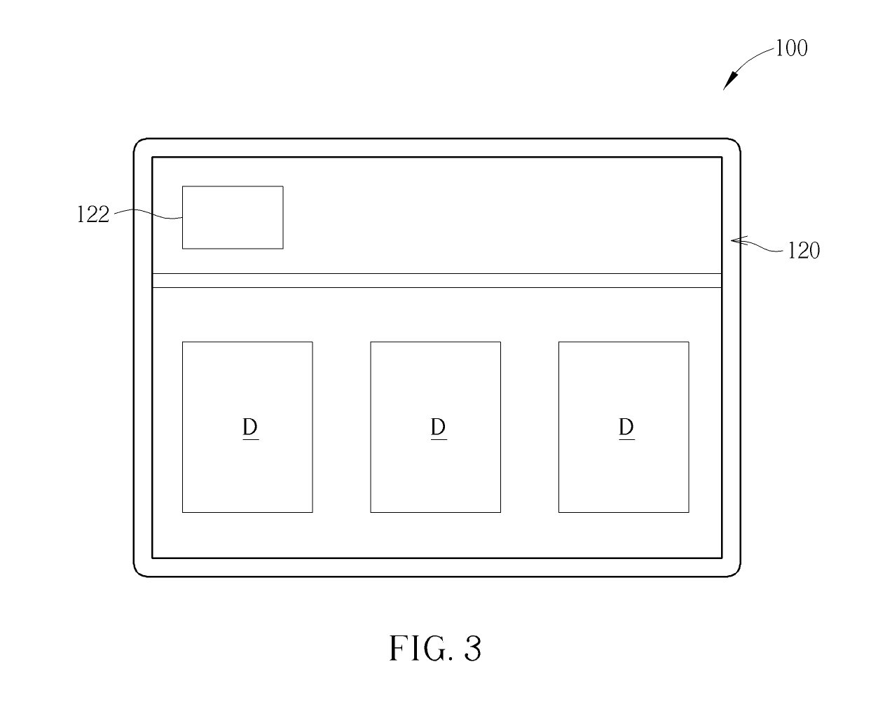

Please refer to FIG. 2 and FIG. 3, and refer to FIG. 1 as well. FIG. 2 is a diagram showing the touch display device 100 of the present invention utilizing a first display interface for displaying a plurality of data objects D. FIG. 3 is a diagram showing the touch display device 100 of the present invention utilizing a second display interface for displaying the plurality of data objects D. As shown in figures, number of the plurality of data objects D displayed on a page of the second display interface is less than number of the plurality of data objects D displayed on a page of the first display interface. In addition, a size of the data objects D displayed on the second display interface is larger than a size of the data objects D displayed on the first display interface. The touch display device 100 of the present invention displays an input option (such as a button image) on a predetermined display area 122 for switching display interfaces. The first display interface and the second display interface are the display interfaces predetermined by the user. The touch display device 100 utilizes the first display interface for displaying the plurality of data objects D stored in a data folder at beginning. The data objects D comprise Internet addresses, document files, audio video stream files, and/or application software files, etc. A way for displaying the data objects D can be displaying open images of the data objects D when being opened. If it is inconvenient to the user to browse the plurality of data objects D stored in the data folder by the first display interface, and the user would like to switch to the second display interface for browsing the plurality of data objects D stored in the data folder, the user can touch the predetermined display area 122 for inputting a command of switching display interfaces, such that the processor 110 will switch the display interface of the touch screen 120 from the first display interface shown in FIG. 2 to the second display interface shown in FIG. 3 according to the command. If the user would like to switch back to the first display interface from the second display interface, the user can touch the predetermined display area 122 again for switching back to the first display interface.

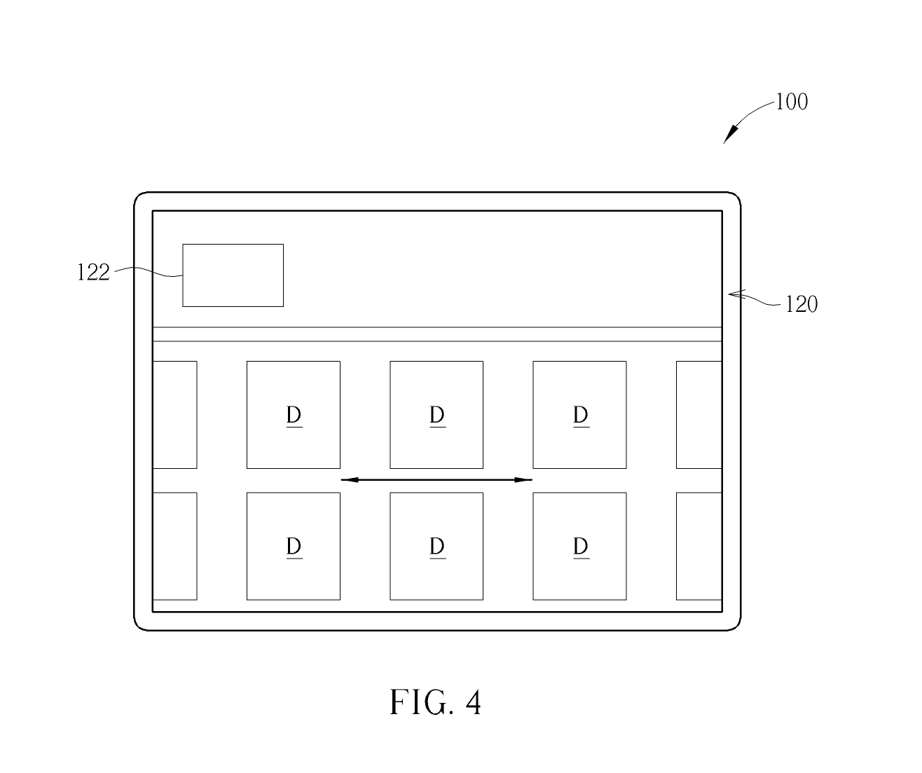

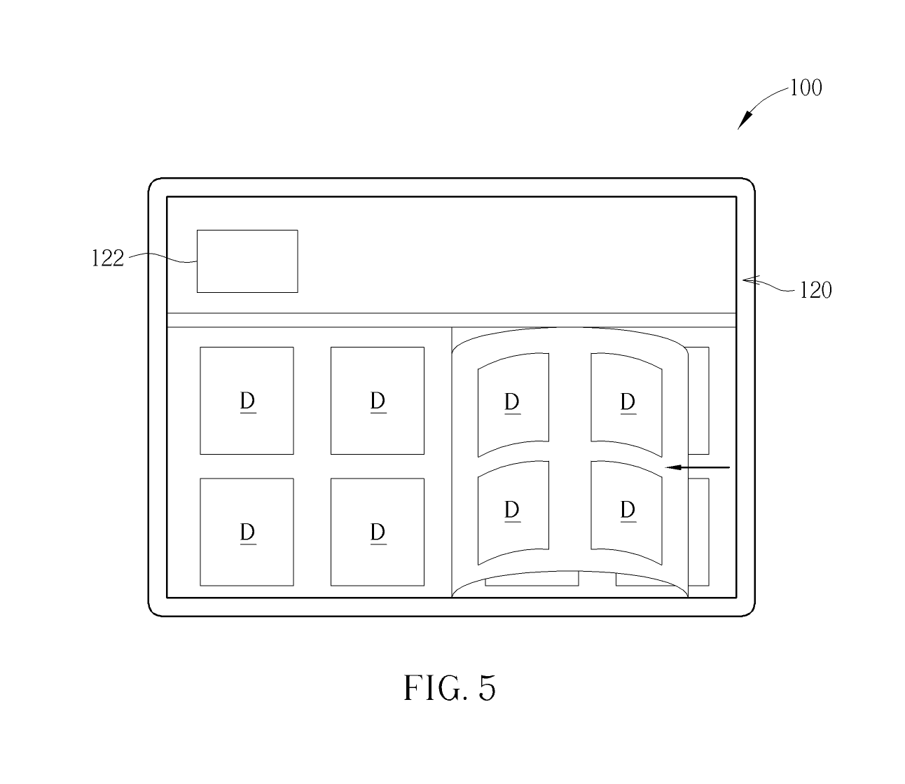

Please refer to FIG. 4 and FIG. 5. FIG. 4 is a diagram showing the touch display device 100 of the present invention utilizing a third display interface for displaying the plurality of data objects D. FIG. 5 is a diagram showing the touch display device 100 of the present invention utilizing a fourth display interface for displaying the plurality of data objects D. As shown in figures, the third display interface moves the plurality of data objects D of the data folder in a manner of sliding the images left and right. The fourth display interface moves the plurality of data objects D of the data folder in a manner of flipping pages. The touch display device 100 utilizes the third display interface for displaying the plurality of data objects D stored in the data folder at beginning. If it is inconvenient to the user to browse the plurality of data objects D stored in the data folder by a way of moving the data objects D provided by the third display interface, and the user would like to switch to a way of moving the data objects D provided by the fourth display interface for browsing the plurality of data objects D stored in the data folder, the user can touch the predetermined display area 122 for inputting a command of switching display interfaces, such that the processor 110 will switch the display interface of the touch screen 120 from the third display interface to the fourth display interface according to the command. Similarly, if the user would like to switch back to the third display interface from the fourth display interface, the user can touch the predetermined display area 122 again for switching back to the third display interface.

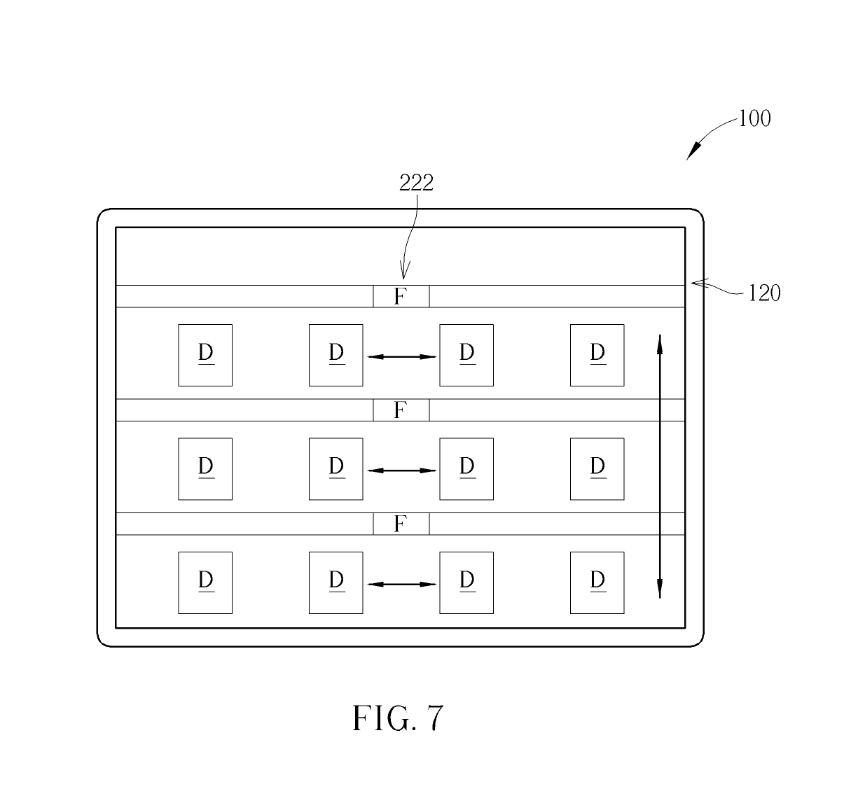

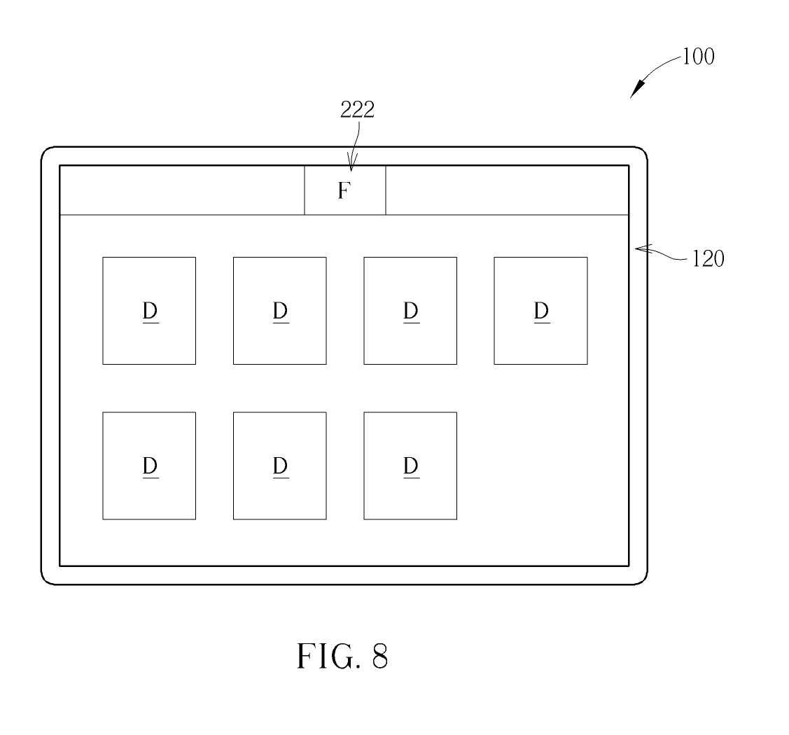

Please refer to FIG. 7 and FIG. 8. FIG. 7 is a diagram showing the touch display device 100 of the present invention utilizing a fifth display interface for displaying the plurality of data objects D. FIG. 8 is a diagram showing the touch display device 100 of the present invention utilizing a sixth display interface for displaying the plurality of data objects D. As shown in FIG. 7, the fifth display interface simultaneously displays a plurality of data files F and the plurality of data objects D stored in the data files. The plurality of data files F can be moved by sliding vertically, and the plurality of data objects D can be moved by sliding horizontally. In addition, when an indication area 222 of the data file F is touched, the plurality of data objects D stored in the data file F can be expanded simultaneously as shown in FIG. 8, such that the user can rapidly find out what data objects D are stored in the data folder F without browsing all the data objects D by sliding horizontally. If the indication area 222 of the data folder F in FIG. 8 is touched again, the display interface is switched back to the fifth display interface. That is, the indication area 222 of the data file F can also be a predetermined display area for switching display interfaces.

In addition, the above method for switching display interfaces is not limited to switching among two display interfaces. The user can predetermine three or more than three display interfaces for allowing the touch display device to switch among three or more than three display interfaces. Furthermore, the above embodiments are examples for illustrating display modes of the display interfaces. The display modes of display interfaces of the present invention are not limited to the above embodiments.

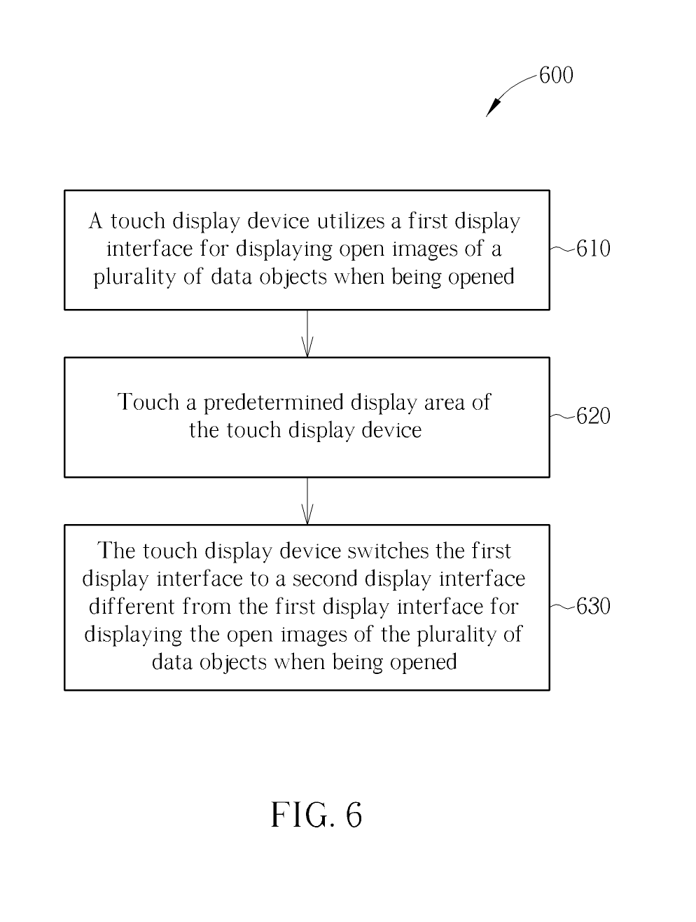

Please refer to FIG. 6. FIG. 6 is a flowchart 600 showing the method for switching display interfaces of the present invention. The flowchart of the method for switching display interfaces of the present invention comprises the following steps:

Step 610: A touch display device utilizes a first display interface for displaying open images of a plurality of data objects when being opened;

Step 620: Touch a predetermined display area of the touch display device; and

Step 630: The touch display device switches the first display interface to a second display interface different from the first display interface for displaying the open images of the plurality of data objects when being opened.

In contrast to the prior art, the method for switching display interfaces of the present invention can predetermine preferred display interfaces, and switch display interfaces among the predetermined display interfaces by touching the predetermined display area on the touch screen. The method for switching display interfaces of the present invention can not only switch display interfaces rapidly, but also increase convenience of use.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for switching display interfaces, comprising:
a touch display device utilizing a first display interface for displaying open images of a plurality of data objects when being opened;
touching a predetermined display area of the touch display device; and
the touch display device switching the first display interface to a second display interface different from the first display interface for displaying the open images of the plurality of data objects when being opened.

2. The method of claim 1, further comprising:
setting the first display interface and the second display interface as predetermined display interfaces of the touch display device.

3. The method of claim 2, wherein the predetermined display area displays a button image.

4. The method of claim 1, wherein the first display interface and the second display interface are predetermined display interfaces.

5. The method of claim 1, wherein number of the open images of the plurality of data objects displayed on a page of the second display interface is different from number of the open images of the plurality of data objects displayed on a page of the first display interface.

6. The method of claim 1, wherein a way of moving the open images of the plurality of data objects displayed on the second display interface is different from a way of moving the open images of the plurality of data objects displayed on the first display interface.

7. The method of claim 1, wherein the plurality of data objects comprise Internet addresses, document files, audio video stream files, and/or application software files.
